(19) United States
(12) Patent Application Publication
(10) Pub. No.: US 2019/0045250 A1
(43) Pub. Date: Feb. 7, 2019

(54) SYSTEM AND METHODS FOR ENABLING USERS TO SELECT AND PRIORITIZE A SET OF CRITERIA

(71) Applicant: Suppose TV LLC, Tiburon, CA (US)

(72) Inventors: Andrew SHAPIRO, Tiburon, CA (US); John TANTUM, Tiburon, CA (US)

(21) Appl. No.: 16/053,683

(22) Filed: Aug. 2, 2018

Related U.S. Application Data
(60) Provisional application No. 62/540,855, filed on Aug. 3, 2017.

(51) Int. Cl. H04N 21/258

(52) U.S. Cl. CPC H04N 21/25891

(57) ABSTRACT

A computer-implemented system and methods for enabling a user or users to select and prioritize a set of criteria are disclosed. Various example embodiments can be configured to enable users to express the relative importance of their preferences with respect to a set of options and that is employed by a process to identify options and generate combinations of options, to filter and rank the set of options or combinations of options with respect to the set of criteria, and to present the options or combinations of options that best fit the expressed criteria to the users.

### PRIORITY PATENT APPLICATION

This non-provisional patent application draws priority from U.S. provisional patent application Ser. No. 62/540,855; filed Aug. 3, 2017. This present non-provisional patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2016-2018, Suppose TV LLC, All Rights Reserved.

### TECHNICAL FIELD

Embodiments of the disclosure relate generally to the field of information processing, content selection, and user interfaces. Embodiments relate more particularly to a computer-implemented system and methods for enabling users to select and prioritize a set of criteria.

### BACKGROUND

As a set of options increases in number, as the collection of properties that describe each option become more extensive and complex, and as the set of criteria used to evaluate the appropriateness of the options become more diverse, the amount of computation complexity and processing time required to filter, rank and identify the most appropriate option or options increases dramatically. This increase in complexity may result in instances where the cost of the resources required exceeds the benefits of such analysis, resulting in a selection of a sub-optimal option or options or in no selection being made at all. There is a need for a way to capture a richer, more informative set of criteria and to do so in a more efficient way than is currently done, and then to employ such a more informative set of criteria to identify an option or a set of options that best satisfy the set of criteria, without requiring personal or computation resources that exceed the benefit of the option selection optimization.

There are many cases in the real world where the proliferation, both in number and complexity, of options has been so great so as to make the cost of finding the best option prohibitive. In particular, there are marketplaces of products or services where the number of items available and the complexity of the properties of such items have increased so greatly that it is not currently practical for a buyer to make an optimal purchase decision.

One such marketplace where this is the case is the video services market. Until recently, the selection of video services was simple. Each homeowner would choose between a package offered by a single cable television provider, or from one of two satellite TV providers. Each of these providers had 3-4 service package options, with Digital Video Recorder (DVR) add-ons, with prices ranging from around $70 to over $180 per month. Over the past 18 months, this market has changed dramatically, as television programming is increasingly delivered over a broadband Internet connection. Many new brands have emerged and grown rapidly, including Netflix™, Amazon™ Prime Video, Hulu™, YouTube™, Sling TV™, PlayStation Vue™ DirecTV Now™, and CBS All Access™. The range of consumer choices for video services has greatly expanded, and the new options provide more content, device, and subscription flexibility. But, each consumer may have specific preferences regarding their preferred content and related features, their willingness to pay with respect to specific content and features, and the relative importance of those preferences, and it is difficult and time consuming to understand and evaluate the many options available with respect to these preferences.

### SUMMARY

The various embodiments described herein address the challenges such as those experienced by consumers in the current video services marketplaces, allowing for more efficient identification of options that best satisfy a given set of selection criteria and the relative importance of such. A computer-implemented system and methods for enabling users to select and prioritize a set of criteria is disclosed herein. The various embodiments described herein:
Provide a method and a system whereby users may identify the criterion or criteria that is important to them individually, to identify the relative importance of those criteria, and to define properties with respect to those criteria. Options are presented to the users with an indication of best fit relative to the specified criteria, criteria properties, and relative importance of the criteria. Such indication may be reflected by relative position in a list or on another graphical display or by a numeric or visual representation that quantifies the degree of fit.
In one example embodiment, the system and methods allow users to use a computing device to select video content (by selecting from a list or searching for specific channels, programs, episodes, actors, directors, characters, program types, subject categories, and sports teams, to name a few) that are most important to them and to reflect the relative importance of the selected video content, either by directly changing the position of the content in a list of the selected content to indicate greater or lesser importance or by taking an action such as clicking on a button, such as a “must-have” button, that indicates that a particular content item is more important than the others.
In other example embodiments, the system and methods allow users to use a computing device to select criteria of different types (content, price, specific features, service provider, or compatible devices), adjust the properties of each criterion, and reflect the relative importance of those criteria, either by directly changing the position of the criteria in a list of the selected criteria to indicate greater or lesser importance or by taking an action such as clicking on a button that indicates that a particular criterion is more important than the others.
In other example embodiments, the system and methods allow users to use a computing device to indicate the relative importance of two or more criteria, whether they be specific channels, programs, all channels and programs as a whole, price, or any other criterion, by moving an indicator closer to or further away from a visual representation of each criterion, with the relative distances of the indicator to each criterion indicating the relative importance of that criterion.
In other example embodiments, a user's location may be automatically detected or specified via direct input of a location by the user.
The system and methods present service options available to the user, displaying the relative fit of the options with respect to the user's specified criteria. Relative fit may be calculated using a process that includes price sensitivity, the user's content preferences, service availability in a specified location, and other criteria as well as the relative importance of those criteria and may be indicated by means of the presence or order of the options in a list, a numeric or visual representation that quantifies the degree of fit, or another visual indication. This analysis and presentation allows the user to compare services and make well-informed purchase decisions.
The system and methods may provide information about video services, including details about content availability, price, purchase options, taxes, fees, one-time costs, service restrictions, playback and recording features, and device compatibility.
The system and methods may also enable the user to filter and rank their video service options on a range of criteria, including:
   Price, in aggregate and for specific content elements, expressed as a minimum or maximum, or as price sensitivity, which indicates importance of reducing price relative to the importance of increasing fit with other criteria, such as preferred content
   The number of simultaneous video streams.
   The types of devices required to obtain the content. Television services are delivered over a range of devices including cell phones, tablets, digital media player set top boxes, and smart TVs.
   The availability and capabilities of the time-shifted, video recording (i.e., DVR, cloud DVR) offering. Criteria in this area may include storage capacity; storage duration; simultaneous recording availability; availability of features to pause, rewind, or fast forward; and ease of use.
   The quality of the user interface for selecting, watching, and saving content.
   The type and quality of content delivery, including picture definition (i.e., SD, HD, 4K, 8K, UHD), speeded-up playback, and sound quality.
   The presence of advertisements, and the ability to skip or fast forward through ads.
The system and methods can present video service options to users that come from a wide range of paid and free video sources, including cable television operators (MVPDs), satellite television operators, over-the-air television broadcasters, over-the-top Internet television providers, and subscription video on demand providers.
The system and methods can combine content and packages from more than one service provider, showing users the total cost, content availability, and features of combined offers.
The system and methods can enable the user to choose multiple different types of services, such as TV and Internet, select criteria that relate to those different types of services and in presenting options combine those of different types of services to best satisfy the chosen service types and selected criteria.
The system and methods can facilitate the user's purchase of services. A user's sign-up information (i.e., name, address, credit card details) is applied to multiple service providers. Orders may be placed on behalf of a user.
The system and methods can manage subscriptions for users, providing them with a single interface to pay for services from multiple service providers. Subscription support may include turning on or off services based on usage (or non-usage), notifying users of special promotions, and identifying subscription changes that reduce costs or add desired content.
The system and methods can generate data that can be used by service providers to improve their understanding of consumer preferences, competitive dynamics, and market demand.
The system and methods can provide a platform for promotion, advertising, lead generation, and customer acquisition by service providers. Service providers can build awareness of their content or service packages, and attract customers who are well suited to their offerings.

The various example embodiments described herein can enable the user to elect to save a set of selection criteria and an initially presented set of options that best fit that criteria, and then at a later time automatically send a notification via any of a variety of communication channels, such as email, SMS, web notification, and mobile notification, whenever the set of options that best fit that criteria change due to additions to, deletions from, and changes in the characteristics of the available options. The system and methods of example embodiments can also incorporate user behavior either captured by monitoring user interactivity with content or otherwise observed into the determination of the criteria, in addition to or instead of user specified criteria, that is used to determine the options that best fit the user's criteria.

### BRIEF DESCRIPTION OF THE DRAWINGS

The various embodiments are illustrated by way of example, and not by way of limitation, in the figures of the accompanying drawings in which:

FIG. 1 is a block diagram of a system for facilitating option selection optimization.

FIG. 2 is a flow chart of an example embodiment of a process for capturing user preferences and requirements with respect to various criteria and displaying options or combinations of options that best satisfy the specified criteria.

FIG. 3 is a flow chart of an example embodiment of a process for identifying and ranking in order of appropriateness, with respect to specified criteria, one or more options or combinations of options that best fit the criteria.

FIG. 4 is a block diagram of an example embodiment of a system and process for managing one or more third-party subscriptions for a user.

FIGS. 5 through 17 illustrate some exemplary user interface controls for selecting criteria, modifying criteria parameters, and setting relative importance of criteria, with respect to a process of identifying the best video service options or combinations of video service options.

FIG. 18 is a flow chart of an example embodiment of a process for enabling a user to explicitly select criteria from which a set of options can be generated for the user.

FIG. 19 is a flow chart of an example embodiment of a process for enabling a system to implicitly select criteria for a user based on the user's interaction with content.

FIG. 20 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

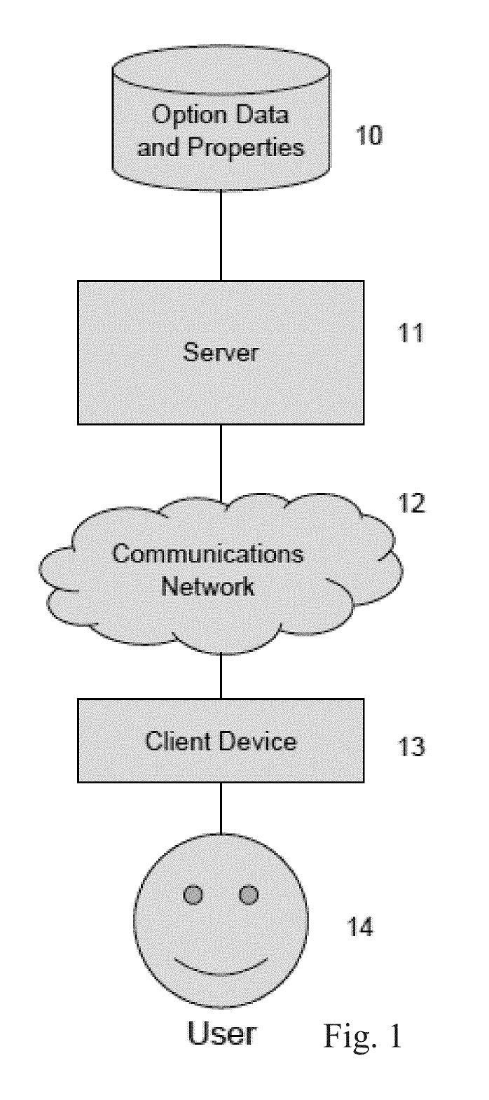

FIG. 1 illustrates a system for facilitating option selection optimization. User 14 utilizes a computing device 13, such as a personal computer or mobile device such as a tablet or mobile phone, to access via a communications network 12 such as the Internet, a server 11 which retrieves data from a database 10 that represents a set of options available to the user for the given subject matter of user's request. In one embodiment, the server 11 stores the options and receives data from the user 14 via the computing device 13 and network 12 indicating the user's preferences with respect to criteria to be used for the selection of options. The server 11 utilizes a process, as described herein, to generate, filter, and rank options or combinations of options to return to the computing device 13 and present to the user 14. In another embodiment, the server 11 delivers to the computing device 13 data representing the set of options available to the user 14. The computing device 13 then receives the data from the user 14 with respect to the criteria and applies the process to return and present the results to the user 14. In another embodiment, the process operates partially on the server 11, returning intermediate data to the computing device 13, and the computing device 13 further processes the intermediate data by applying the remaining methods of the process to the intermediate data to return and present the results to the end user 14.

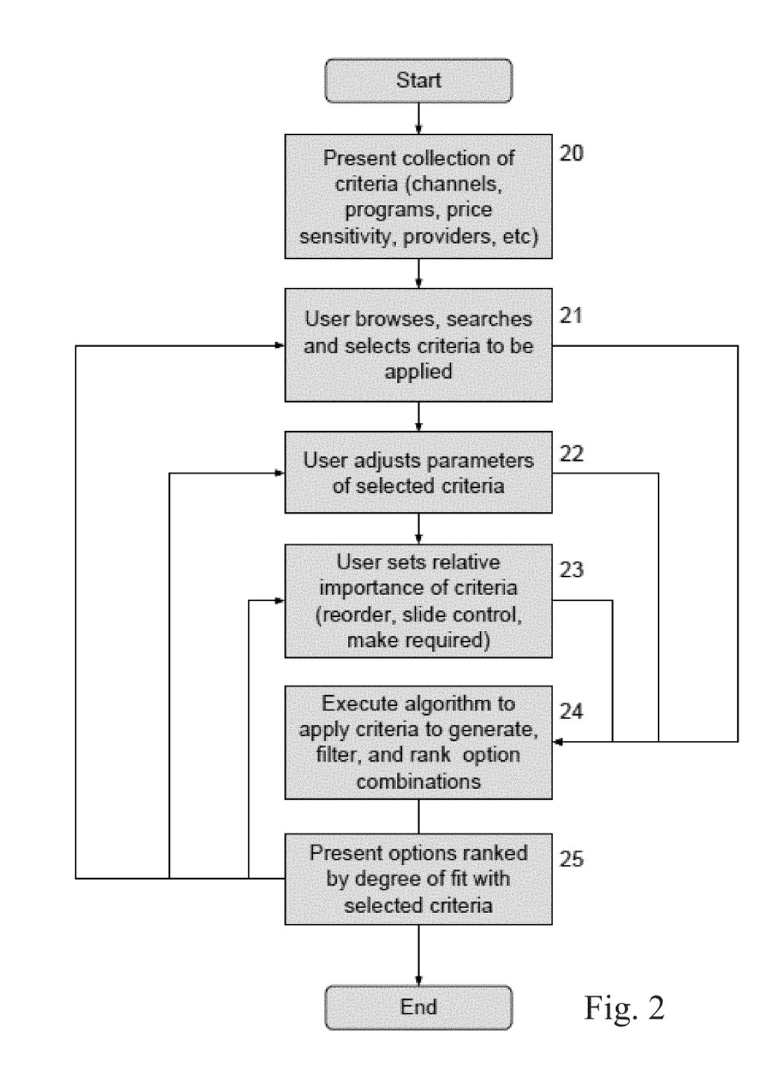

FIG. 2 illustrates a process for collecting user specifications in order to identify criteria, properties of such criteria, and relative importance of such criteria, to be used by a process to generate, filter, and rank options or combinations of options that best fit the user's specifications. In step 20, the user is presented with one or more collections of criteria from which the user may select one or more criterion. In an example embodiment, this may be a list of television channels or programs that, by selection, the user can indicate that such channels or programs should be included in the options returned by the process. These criteria may also include location (such as a particular geographical area where service options must be available), providers of the desired options (including products or services such as cable, satellite, or Internet television providers), devices that are compatible with such products or services, features of such products or services (such as whether a digital video recording feature is available), and price (including the one-time or recurring price of products or services related to the options returned). In step 21, the user may browse, search, and select those criteria that should be used by the process. In step 22, the user may adjust the parameters of the selected criteria (such as specifying which providers to include, which devices to require compatibility, or what the maximum price must be). In step 23, the user may specify the relative importance of each criteria by adjusting the order of the criteria within a list (such as re-ordering a list of channels or programs), by specifying that a particular feature be required (such as requiring that a channel or program be included in all options or specifying that digital video recording functionality must be available), or by dragging a slider between two or more criteria to indicate by proximity which of those criteria are more important than the others (such as dragging a slider toward a price criterion and away from a content criterion to indicate that saving money is more important than having all of the specified channels or programs).

In step 24, a process is executed, taking into consideration any criteria, including parameters and relative importance, specified in steps 21, 22, or 23, to generate options or combinations of options that best satisfy the specifications, to filter out any that are inconsistent with the specifications, and to rank the options according to the degree of fit with the specifications. In step 25, the resulting options are presented to the user on a visual display, either as an ordered list or other graphic representation that illustrates the relative fit of each option.

Steps 24 and 25 may be executed in sequence after each of steps 21, 22, and 23 are performed or may occur iteratively as each step is performed, thus providing feedback to the user as the steps are performed and allowing for the return of results without necessarily completing each step.

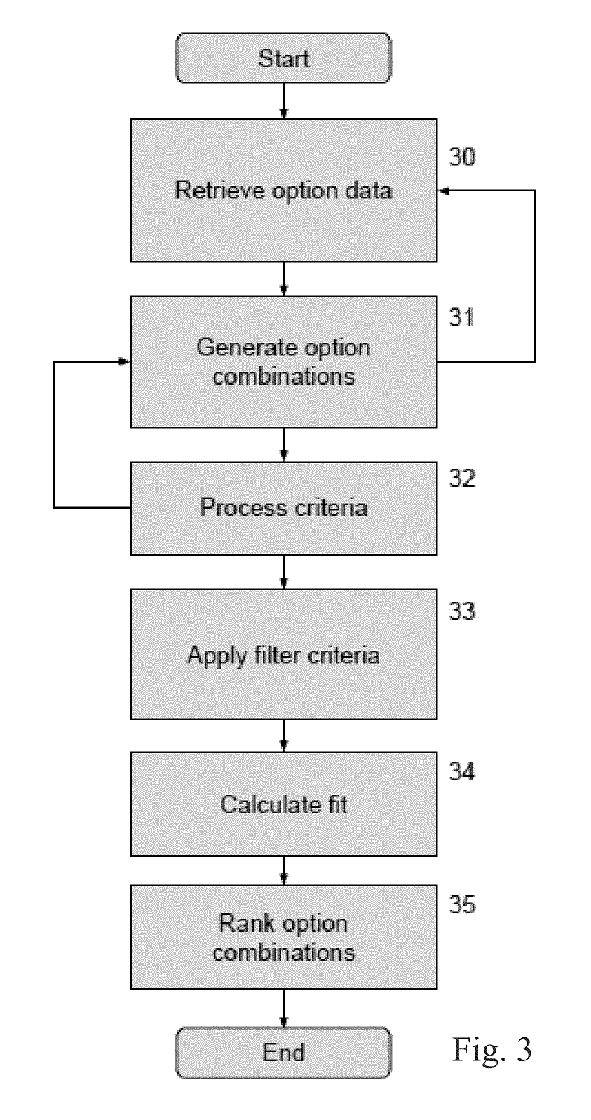

FIG. 3 illustrates in greater detail the process of an example embodiment for generating, filtering, and ranking combinations or combinations of options. In step 30, the processing device retrieves option data (such as a collection of service offerings and the contents, features, and pricing of those service offerings) from stored memory, either from a server via a network or from a database or memory resident in the processing device. In step 31, a preliminary set of options or combinations of options may be identified based on initial user specifications (such as location or preferred providers). In step 32, user-specified criteria may be captured, at which point, step 31 may be repeated in order to generate additional options or combinations of options. In step 33, the options may be filtered by eliminating any options that are inconsistent with the specified criteria. In step 34, a fit may be calculated for each criterion using a formula unique to that criterion, and a total fit may be determined by combining the fit of all the criteria by applying a weighting to each criteria based on the relative importance specified by the user. In step 35, the remaining options and combination of options may be ranked in order of the total fit and returned for display to the user.

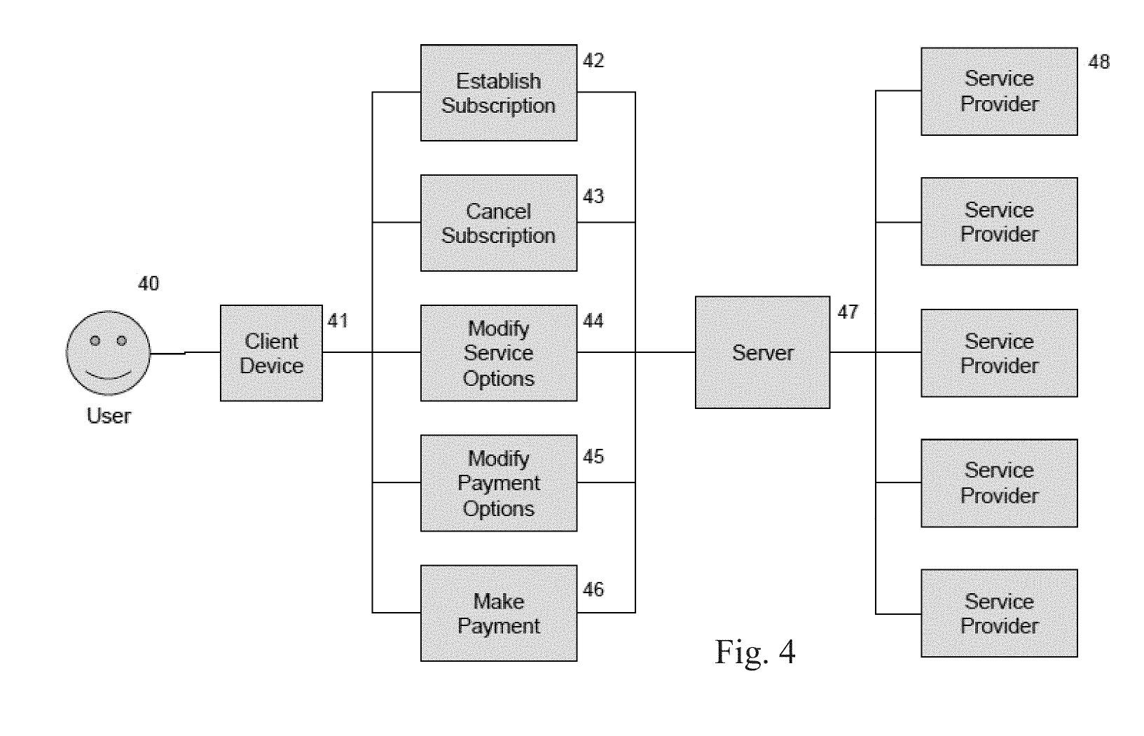

FIG. 4 illustrates a block diagram of a system and process that enables a user to manage subscriptions to services (such as cable, satellite, or Internet video services, etc.). The user 40 uses a client device 41 (such as a television, television set-top box, personal computer, tablet, or mobile phone, etc.) to access a list of available service subscriptions. The user may select one or more services and request to establish a subscription 42 with those services. A server 47 can receive that request and initiate contact with the third-party service providers 48 of those services and establish those service subscriptions under the account of the user. A user may subsequently access a list of subscriptions and choose to cancel one or more subscriptions 43 either immediately or at a specified future date, modify service options 44 with regard to one or more services (such as whether a DVR feature is enabled or to receive reminders of important subscription related dates such as payment due dates or subscription expiration dates, etc.), modify payment options 45 (such as adding monthly auto-pay updating credit card information) with regard to one or more services, or initiate a payment 46 (such as making a payment of one or more subscription fees) that will be received by the server and distributed to each respective third-party service provider.

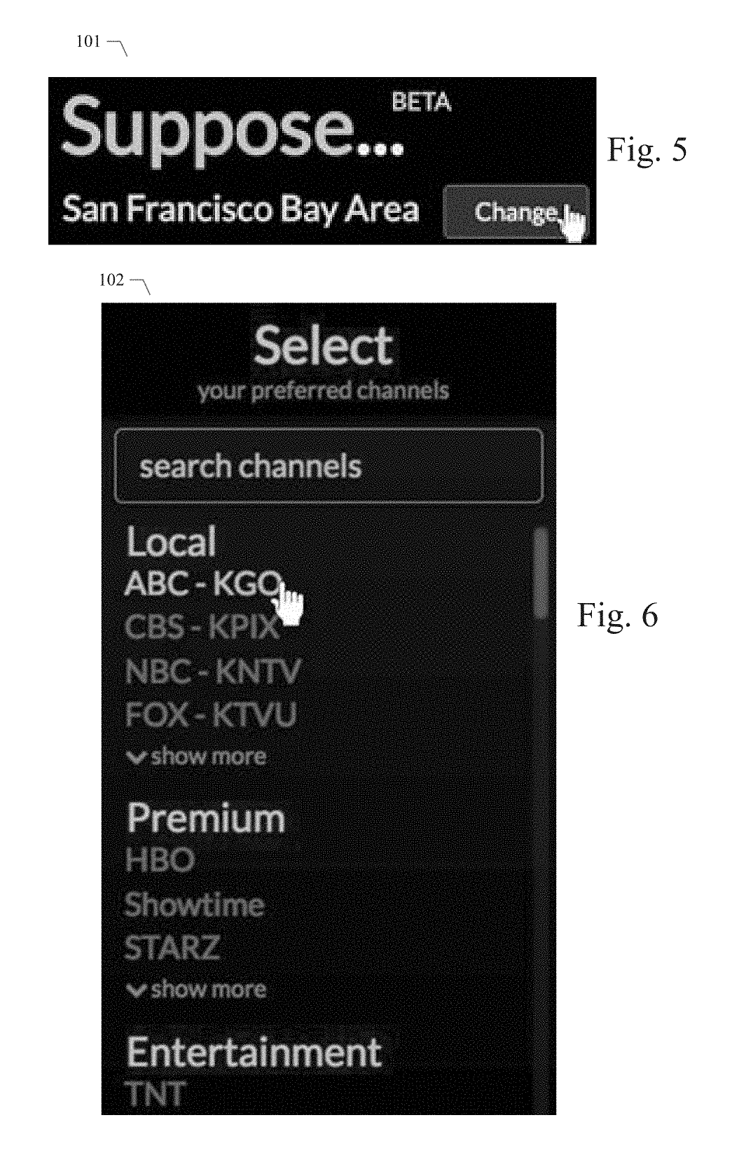

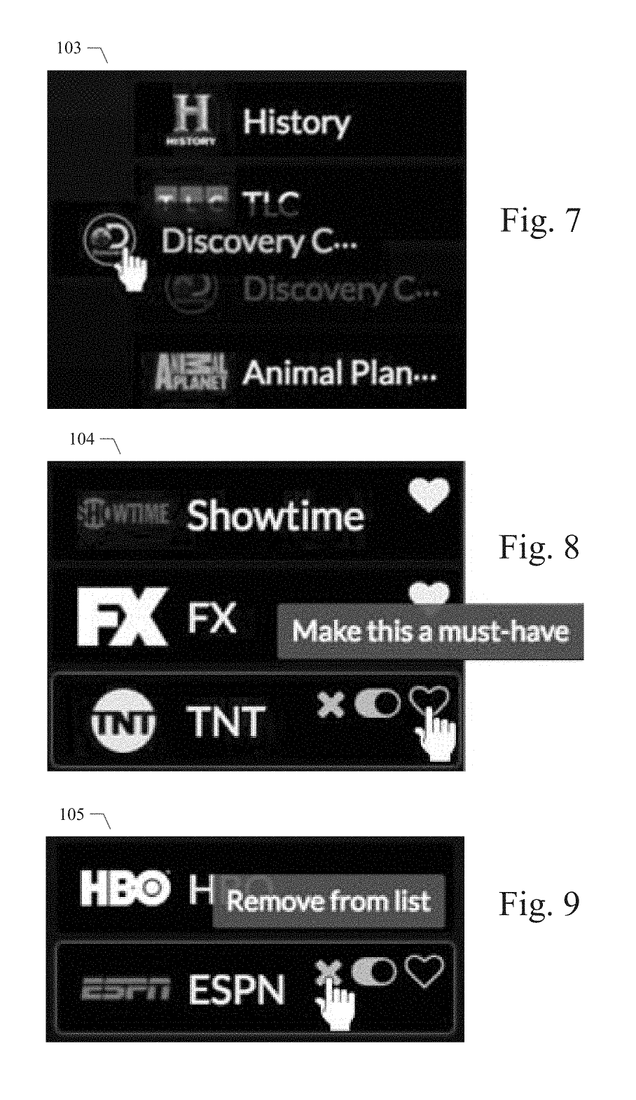

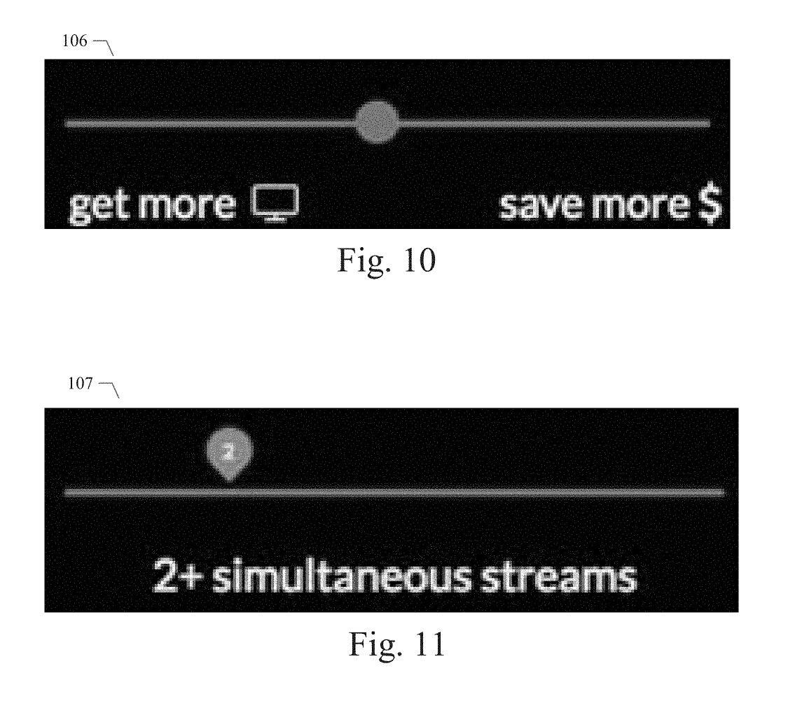

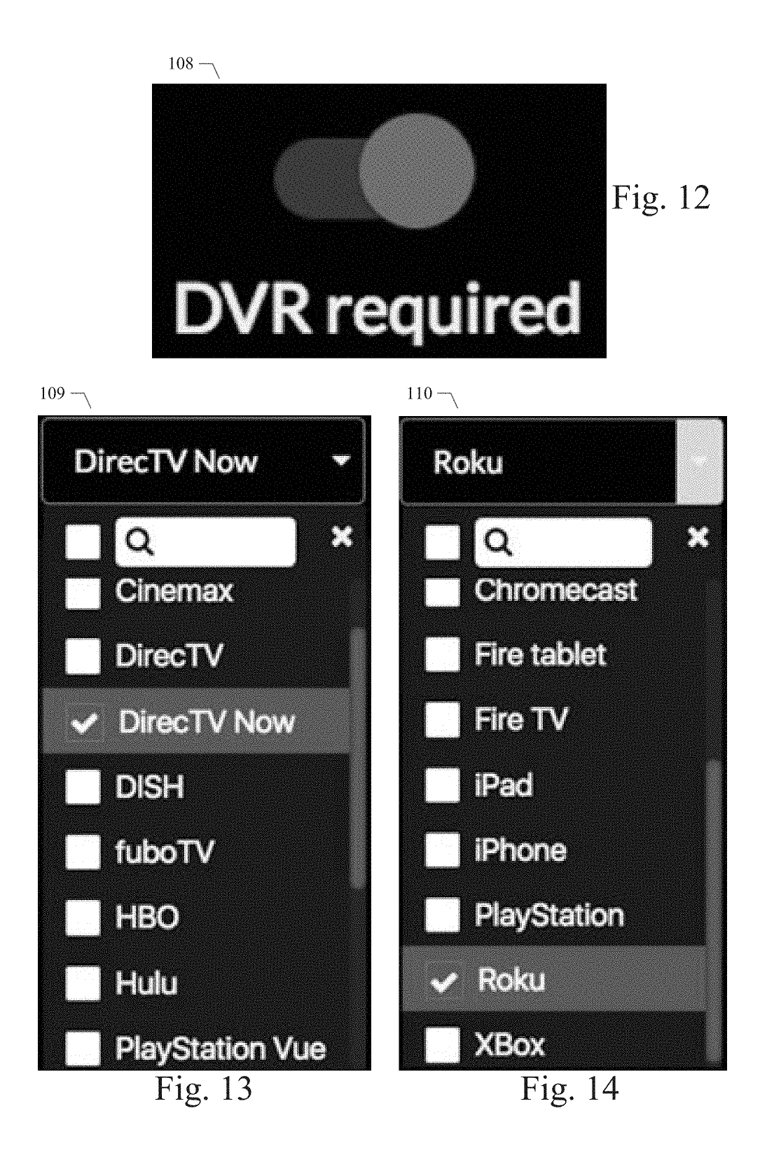

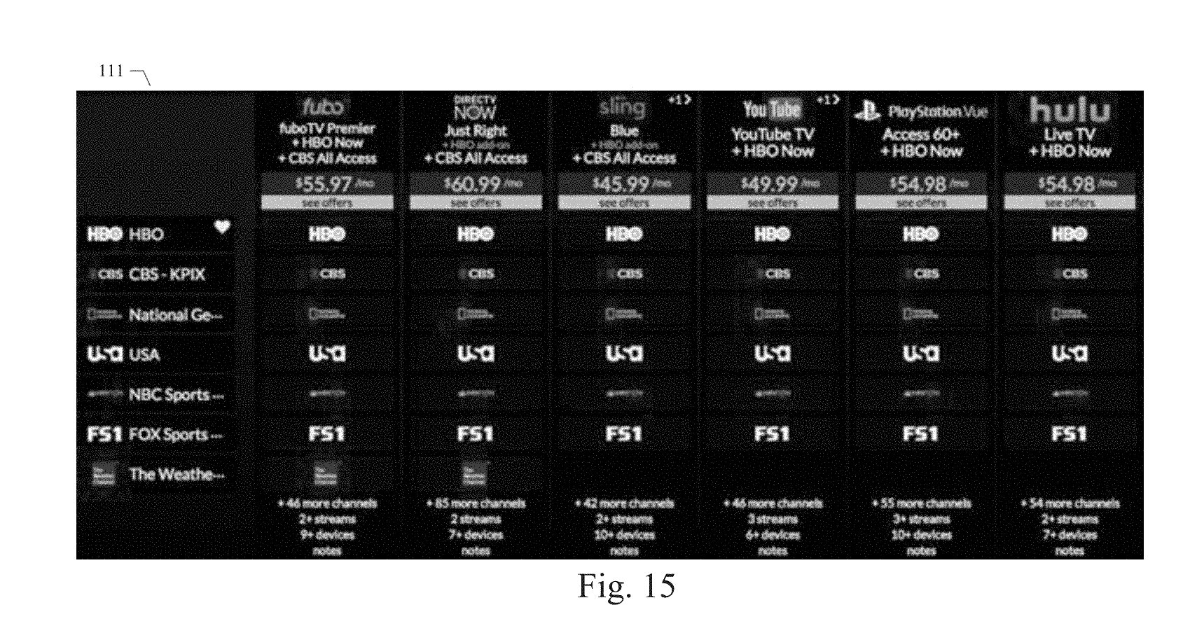

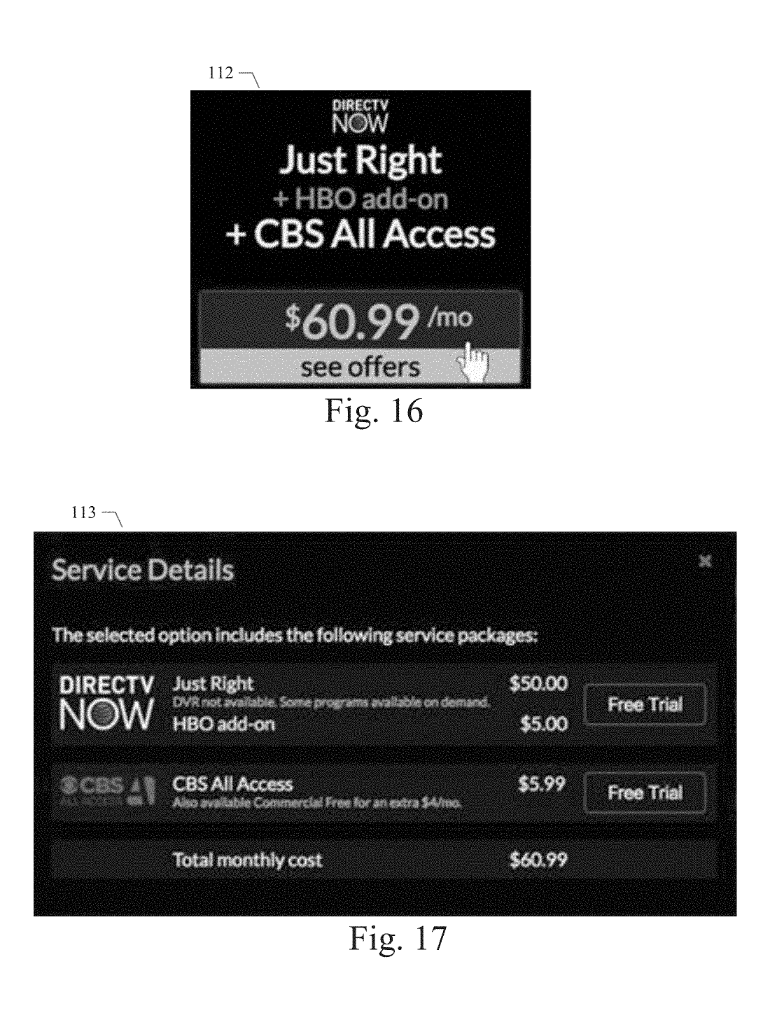

FIGS. 5 through 17 illustrate some exemplary user interface controls for selecting criteria, modifying criteria parameters, and setting relative importance of criteria, with respect to a process of identifying the best video service options or combinations of video service options. Control 101 (shown in FIG. 5) illustrates that a user may enter a location to determine the service area for which options should be retrieved. Control 102 (shown in FIG. 6) illustrates how a user may browse or search a list of channels to select the channels that are preferred. Control 103 (shown in FIG. 7) illustrates how a user may indicate that one channel is more preferred than other channels by dragging the channel to a higher position in the list of selected channels. Control 104 (shown in FIG. 8) illustrates how a user can require that a channel be included in returned service options by clicking a “must-have” indicator. Control 105 (shown in FIG. 9) illustrates that a user may remove a selected channel from the list. Control 106 (shown in FIG. 10) illustrates how a user may drag a slider in one direction to prioritize results with lower prices and in the opposite direction to prioritize results with greater fit with the selected channels. Control 107 (shown in FIG. 11) illustrates how a user may require that returned options allow for a minimum number of simultaneous video streams. Control 108 (shown in FIG. 12) illustrates how a user may require that the returned options allow for digital video recording (“DVR”) functionality. Control 109 (shown in FIG. 13) illustrates how a user may restrict results to specific service providers. Control 110 (shown in FIG. 14) illustrates how a user may require service option compatibility with specific devices. Control 111 (shown in FIG. 15) illustrates how option results may be returned to the user for visual comparison of results. Control 112 (shown in FIG. 16) illustrates how the user may select one option to see more details of the offers. Control 113 (shown in FIG. 17) illustrates how the user may view the details of the service options and connect to the providers of the services.

### Example Scenarios of User Interactions

Alice is unhappy that she spends $132 each month for her DirecTV™ satellite TV subscription, since she and her two teenage daughters only watch a handful of the 200+ channels they receive. She wants to explore her options, and find a more suitable television service package. A Google™ search directs her to a website, where she confirms her location in suburban Atlanta. She then selects the television channels and programs that she and her daughters watch, choosing from a list and entering items in a search box. She selects her local Fox™ and ABC™ affiliates, where she gets her daily weather reports. She selects Comedy Central™, National Geographic Channel™, History Channel™, E! ™, USA™, Bravo™, and HBO™. She selects her family's favorite programs—The Good Fight™, Billions™, and Homeland™. She selects important live events—the NBA™ playoffs, the Oscars™, and the Grammy Awards™. The system behind the website presents options to her, showing her how she can have access to her preferred content through different combinations of service providers, with different tiers of service, and at different prices. Alice sorts her channels, programs, and live events according to her priorities, and the system dynamically updates the options it presents to her. She sets criteria for the number of simultaneous streams her family requires (3), and that they must be able to watch using all their existing devices (iPhones™, an Android™ tablet, and a Roku™) To get every channel and show her family desires is still prohibitively expensive—over $120 per month—so Alice expresses her preference for lower cost, and she is presented with options that suit her needs. She narrows her options down to the final few, where she compares the details—taxes, fees, restrictions, and other requirements. Finally, she selects and clicks through to her family's chosen packages—Play Station Vue™ Access package plus HBO Now™, which will cost her $55 per month. She is redirected to these providers' websites, where she completes the transaction.

Peter is a 25 year-old from Chicago. Since he moved out of his parents' house at age 20, he has never subscribed to a television service himself. He has relied on free YouTube™ videos, his parents' Netflix™ subscription, and an antenna on top of the TV in his apartment. He has recently become increasingly interested in watching professional soccer, so is looking for ways to get that content. He is directed to a website from a friend's Facebook™ post. He selects the content he desires—Premier League™ soccer games, MLS™, Bundesliga™ soccer games, and the FOX™ Soccer Plus channel. He will watch on his iPad™, and his roommate may sometimes watch simultaneously on the apartment's TV using a Roku™, so Peter sets these as criteria for his search. He sorts his preferred content according to his priorities, and labels certain content as “must have”. He is presented with options that meet his requirements, at various prices and with different features. He decides that YouTube™ TV with the Fox™ Soccer add-on is the best package for him since it also includes ESPN™ and Fox News™ (for his girlfriend). It includes unlimited cloud DVR storage, which is critical for him since he rarely watches live games. He is okay paying the $50 per month during the soccer season, but pre-arranges to have his subscription cancelled at the end of the season. He requests to be reminded to re-initiate his subscription at the start of next season.

Another illustration: A user may specify ten channels that they favor, and rank them from one to ten. The minimum cost of service packages that provide all ten channels, while also satisfying their other criteria, may be $70 per month. Other services packages offer fewer of the ten priority channels, at lower cost. For example, service packages that include nine of the ten channels may be available for $60, and service packages that include eight of the ten channels may be available for $55. A more price sensitive user may choose a cheaper package and give up certain channel. A less price sensitive user may require all ten channels and pay $70. The price sensitivity tool controls whether packages with more content or packages with lower prices are prioritized in the results list and lets the user explore these tradeoffs.

### Alerts

The system and methods may enable the user to elect to save a set of selection criteria and an initially presented set of options that best fit that criteria, and then at a later time send a notification via any of a variety of communication channels, such as email, SMS, web notification, and mobile notification, whenever the set of options that best fit that criteria change due to additions to, deletions from, and changes in the characteristics of the available options. The notification may indicate that there is a change in the best fit options for the given set of selection criteria and provide the user, or direct the user to a web page, with details of the change and the current set of best fit options.

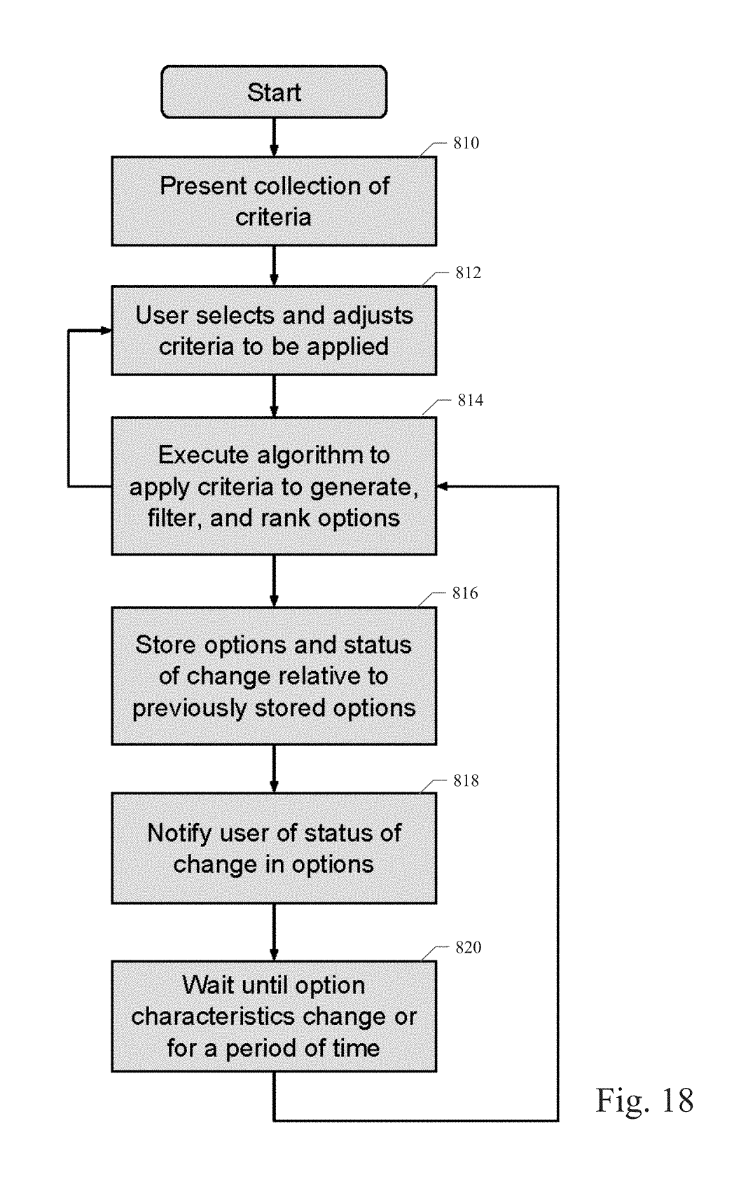

In various example embodiments, the criteria selection or generation can be performed explicitly by user selection or implicitly based on user interactivity with content. FIG. 18 is a flow chart of an example embodiment of a process for enabling a user to explicitly select criteria from which a set of options can be generated for the user. Referring to FIG. 18, a user is presented with a collection of criteria from which the user can explicitly select desired criteria (block 810). The user can select and adjust the criteria to be applied in block 812. The system of an example embodiment can use the user-selected criteria to generate, filter, and rank options for the user based on the explicitly selected criteria (block 814). The system-generated options and status related to previously stored options can be retained and associated with the user (block 816). The user can be notified of a change in the status of the user's options (block 818). The system can wait until option characteristics change or until a pre-determined period of time has elapsed (block 820). At that time, the system can return to block 814 where the system can use the user-selected criteria to generate, filter, and rank options for the user based on the explicitly selected criteria. If desired, the process flow can also return to block 812 where the user can select and adjust the criteria to be applied to the option generation process.

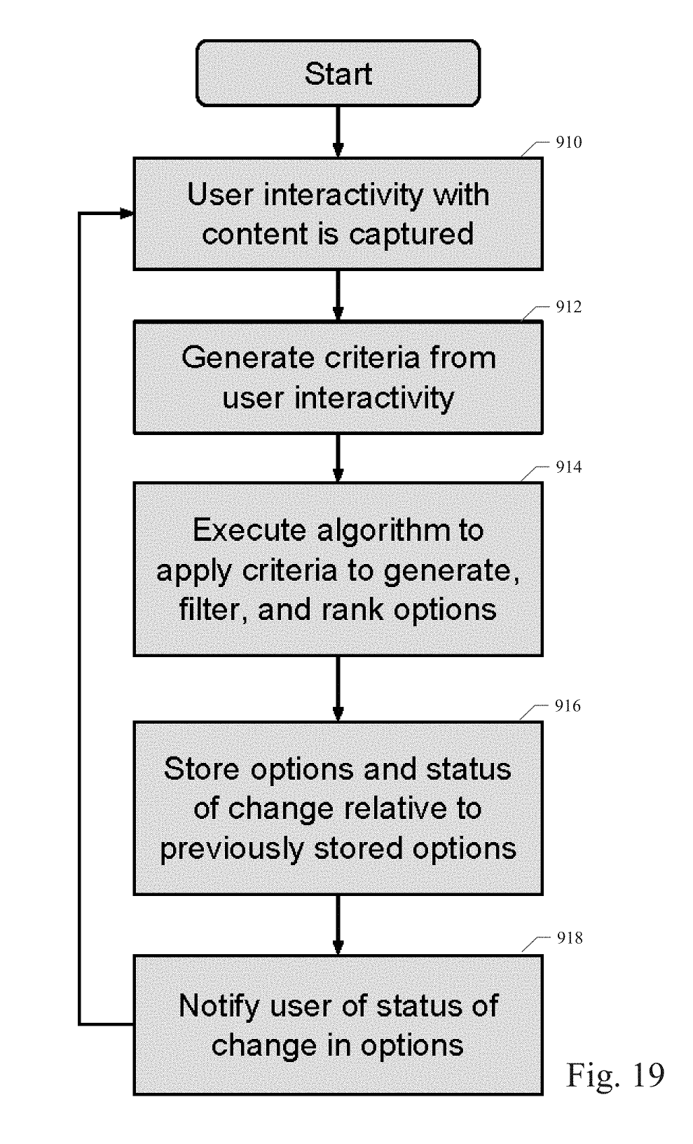

FIG. 19 is a flow chart of an example embodiment of a process for enabling a system to implicitly select criteria for a user based on the user's interaction with content. Referring to FIG. 19, the user's interaction with content or behavior can be tracked and captured (block 910). For example, the system can track the user's frequent consumption of content from a particular source, content of a particular type or genre, content presented at a particular time and place, or the like. The system of an example embodiment can use the user's interaction with content or behavior to implicitly generate criteria from the user's behavior (block 912). The system of an example embodiment can use the implicitly generated criteria to generate, filter, and rank options for the user based on the implicitly generated criteria (block 914). The system-generated options and status related to previously stored options can be retained and associated with the user (block 916). The user can be notified of a change in the status of the user's options (block 918). The system can continually process variations in user interactivity, wait until option characteristics change, or wait until a pre-determined period of time has elapsed. In any case, the system can return to block 910 where the user's interaction with content or behavior can be tracked and captured again.

### Implicit Criteria

As described above in connection with FIG. 19, the system and methods of example embodiments can incorporate user behavior either captured by monitoring user interactivity with content or otherwise observed into the determination of the criteria, in addition to or instead of user specified criteria, that is used to determine the options that best fit the user's criteria. For example, if a user is watching a specific set of channels on a regular basis, a set of options that may be a better fit with the user's watching patterns may be presented directly to the user or via a notification. For example, user interface software on a content device may include functionality that identifies data representing what content is being consumed by a user by recording the content selection actions of the user, such as selecting a channel, program, episode, subject category, or sports team, or observing the characteristics of the content being consumed, such as performers, actors, directors, characters, subject categories, and program types as well as playback time, duration, frequency, location, and device type. Such data may be collected by software on a device separate from, but in proximity to, the content device that captures audio or visual representations of the content that is being consumed and analyzes it to determine user behavior. The data may then be incorporated as criteria that is used to determine a set of options, such as a video service or combination of video services, which is presented to the user.

### Dependencies

The system and methods may enable the user to identify one or more products or services that the user has purchased or is considering purchasing and then include within a presented set of options those which are available specifically to users that have those products or services. For example, a user who subscribes to a particular service, such as Amazon Prime™ may be able to purchase video channels, such as HBO™ and Showtime™, which are not otherwise available to those who do not subscribe to the service.

The system and methods of example embodiments can be applied across a variety of application areas, including services, products, and non-commercial choices. Examples of these applications for the system and methods of the various disclosed embodiments are described below.

### Service Applications

Hotels: The criteria used to evaluate the appropriateness of hotel options may include availability dates, location, proximity to attractions, parking, restaurants, internet access, amenities like gyms or pools, ambiance, room type, bed type, cancellation and change policies, availability, and cost.

Flights: The criteria used to evaluate the appropriateness of flight options may include availability dates, departure airport, arrival airport, schedule, stops, plane changes, seats, cabin classes, baggage policies, meals, entertainment, internet, aircraft type, cancellation and change policies, and cost.

Cruises: The criteria used to evaluate the appropriateness of cruise options may include availability dates, destination, departure port, arrival port, cruise line, duration, themes or cruise type, dining options, amenities like gyms or pools, entertainment, food and drinks, age of ship, size of ship, cabin types, ships, ports of call, and cost.

Vacation Rentals: The criteria used to evaluate the appropriateness of vacation rental options may include location, availability dates, proximity to services, rooms, square footage, parking, building type, neighborhood features, internet, laundry, amenities (e.g., gyms, pools, etc.), and cost.

Rental Cars: The criteria used to evaluate the appropriateness of car rental options may include availability dates, pick-up location, drop-off location, vehicle type, size, color, safety and self-driving features, safety ratings, entertainment, fuel efficiency, cancellation and change policies, and cost.

Broadband Services, including fixed and mobile connectivity: The criteria used to evaluate the appropriateness of broadband internet options may include availability at specified locations, download/upload speeds, technology, data caps, availability of related services (e.g., phone, SMS, video, security, etc.), contract length, and cost.

Cell Phone Services: The criteria used to evaluate the appropriateness of cell phone service options may include coverage at specified locations, availability of family- or multi-line plans, data limits, download/upload speeds, technology, devices, device financing options, contract length, availability of related services like video, and cost.

Home Security: The criteria used to evaluate the appropriateness of home security options may include sensor type, alert types, video access and storage, activity log availability, professional monitoring, connectivity technology, battery length, contract length, and cost.

Medical Care: The criteria used to evaluate the appropriateness of medical care options may include location, insurance acceptance, procedure frequency, patient outcomes, safety ratings, mortality rates, facilities, ratings, specialized care availability, and cost.

Financial Services, including investment products, insurance, credit cards, loans, mortgages, brokerage services, and banking services: The criteria used to evaluate the appropriateness of financial service options may include interest rates, fees, historical returns, loyalty rewards, coverage levels, risks, penalties, customer support, fiduciary commitment, and costs.

Education Services, including college, K-12, pre-K, technical/trades, and graduate schools. The criteria used to evaluate the appropriateness of education options may include programs of study, location, graduate outcomes, ratings, student characteristics, activities, residential life, financing options, fees, and costs.

### Products

Electronic Devices, including computers, mobile phones, smart speakers, video cameras, watches, televisions, home automation devices, and medical alert devices: The criteria used to evaluate the appropriateness of electronic device options may include size, weight, battery life, operating system, display/screen qualities, audio qualities, memory, processing power, and cost.

Automobiles: The criteria used to evaluate the appropriateness of automobile options may include vehicle type, motor type, size, weight, color, safety and self-driving features, safety ratings, entertainment, fuel efficiency, acceleration, braking, interior features, exterior features, financing options, and cost.

Real Estate, including home or apartment purchases or leases: The criteria used to evaluate the appropriateness of real estate options may include location, proximity to services, rooms, square footage, parking, lot size, age, building type, schools, neighborhood features, amenities like gyms or pools, financing options, and cost.

Drugs and Medications, including pharmaceuticals, over-the-counter drugs, nutraceuticals, and recreational drugs: The criteria used to evaluate the appropriateness of drug and medication options may include potency, efficacy, effectiveness, delivery methods, side effects, addictiveness, interactions with other drugs, and cost.

### Non-Commercial Choices

Relationships: The criteria used to evaluate the appropriateness of relationship options may include sex, age, location, education, interests, employment, physical characteristics, and personality traits.

Charities: The criteria used to evaluate the appropriateness of charity options may include category or cause, location, size, governance, administrative costs, and fundraising costs.

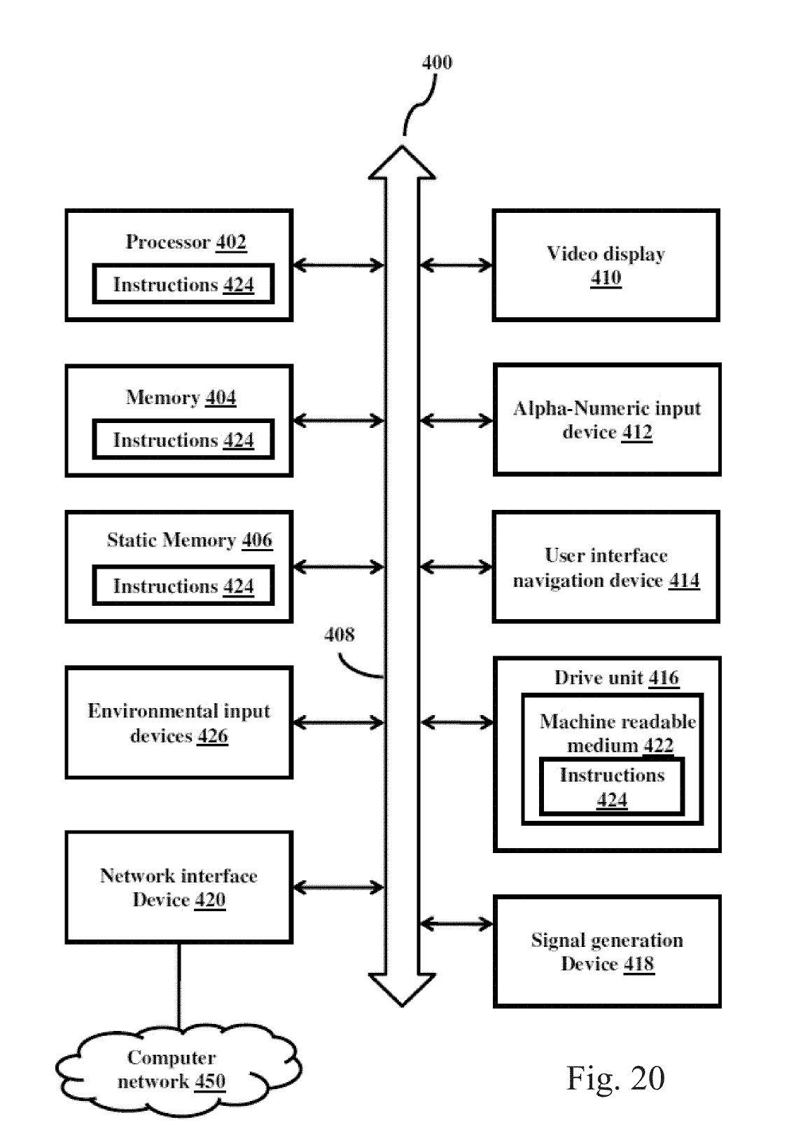

FIG. 20 is a block diagram of a machine in the example form of a computer system 400 within which instructions for causing the machine to perform any one or more of the methodologies described herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies described herein.

The example computer system 400 includes a processor 402 (e.g., a central processing unit (CPU), a graphics processing unit (GPU), or both), a main memory 404, and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker), and a network interface device 420.

The computer system 400 may also include an environmental input device 426 that may provide a number of inputs describing the environment in which the computer system 400 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

The disk drive unit 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions 424 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks. The instructions 424 may further be transmitted or received over a computer network 450 using a transmission medium. The instructions 424 may be transmitted using the network interface device 420 and any one of a number of well-known transfer protocols (e.g., HTTP).

Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans™ or Enterprise Java Beans™. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE™ standard 802.11 including its sub-standards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example, as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

What is claimed is:

1. A system for filtering and ranking video service options by applying criteria supplied by users, the system comprising:
a data processor; and
processing instructions executable by the data processor for:
receiving, from a user, criteria regarding their preferred video services, the criteria including content preferences and service selections; and
filtering, sorting, and ranking video service options according to the user's criteria, the filtered video service options including service packages from a single provider or multiple providers.

2. The system of claim 1 wherein the content preferences and service selections include channels, programs, episodes, actors, directors, characters, program types, price, price sensitivity, device compatibility, service providers, video recording functionality, video playback functionality, or user interface design.

3. The system of claim 1 wherein the system being further configured to enable a user to specify the relationships between the criteria used to filter a set of options to refine the user's preferences.

4. The system of claim 1 wherein the system being further configured to receive, from a user, criteria that express their preferred criteria; these criteria can be selected from lists, searched, or entered by a user.

5. The system of claim 1 wherein the system being further configured to allow a user to specify the relationship between criteria, including: sorting criteria within a prioritized list, ranking criteria, indicating certain criteria are essential, applying weights to criteria, signifying the relative importance of criteria, applying these sorted or otherwise prioritized criteria to filter and optimize a set of options, and presenting results that reveal the best options for a particular user.

6. The system of claim 1 wherein the system being further configured to enable a user to express the degree to which changes in price affect their demand for a product or service.

7. The system of claim 1 wherein the system being further configured to receive, from a user, an indication of their price sensitivity, and using this information to present service options that reflect either: lower price with less optimized fit with other criteria and features preferences; or higher price with better optimized fit with other criteria and features.

8. The system of claim 1 wherein the system being further configured to present a tool in one or more of a variety of controls, including a continuously adjustable slider, a switch, a dial, a button, a numeric entry, or a menu selection.

9. The system of claim 1 wherein the system being further configured to present filtered results of product or service options that reflect a lesser or greater sensitivity to price.

10. The system of claim 1 wherein the system being further configured to create composite options by combining two or more options to meet filter criteria for evaluation and filtering and ranking composite options against user-defined criteria, including: evaluating options that include single or multiple options from a single source, such as from a single service provider and including add-on packages; and single or multiple options from two or more sources, such as from multiple service providers and including add-on packages; and filtering and ranking composite options by combining the respective properties of the composite options and applying user specified criteria to the combined properties.

11. A system for filtering and ranking service options by applying criteria, the system comprising:
a data processor; and
processing instructions executable by the data processor for:
receiving, from a user, information indicative of criteria regarding their preferred services, the criteria including product preferences or service selections; and
filtering, sorting, and ranking service options according to the user's criteria, the filtered service options including service packages from a single provider or multiple providers.

12. The system of claim 11 wherein the information indicative of criteria can be criteria explicitly selected by the user.

13. The system of claim 12 wherein the system being further configured to enable a user to specify the relationships between the criteria used to filter a set of options to refine the user's preferences.

14. The system of claim 12 wherein the system being further configured to receive, from a user, criteria that express their preferred criteria; these criteria can be selected from lists, searched, or entered by a user.

15. The system of claim 11 wherein the information indicative of criteria can be criteria implicitly generated by the system based on user behavior.

16. The system of claim 15 wherein the user behavior includes retaining data corresponding to the user's previous interactions with the service options.

17. The system of claim 11 wherein the system being further configured to automatically send an alert or notification to the user via any of a variety of communication channels whenever the service options change.

18. A method for filtering and ranking video service options by applying criteria supplied by users, the method comprising:
receiving, from a user, criteria regarding their preferred video services, the criteria including content preferences and service selections; and
filtering, sorting, and ranking video service options according to the user's criteria, the filtered video service options including service packages from a single provider or multiple providers.

19. The method of claim 18 wherein the content preferences and service selections include channels, programs, episodes, actors, directors, characters, program types, price, price sensitivity, device compatibility, service providers, video recording functionality, video playback functionality, or user interface design.

20. The method of claim 18 further including enabling a user to specify the relationships between the criteria used to filter a set of options to refine the user's preferences.
